(19) United States
(12) Patent Application Publication
(10) Pub. No.: US 2012/0146942 A1
(43) Pub. Date: Jun. 14, 2012

(54) TOUCH PANEL

(75) Inventors: Kenta KAMOSHIDA, Arakawa-ku (JP); Kiyoshi Watanabe, Arakawa-ku (JP)

(73) Assignee: OPTREX Corporation, Arakawa-ku (JP)

(21) Appl. No.: 13/323,181

(22) Filed: Dec. 12, 2011

(30) Foreign Application Priority Data
Dec. 14, 2010 (JP) 2010-278643

(51) Int. Cl. G06F 3/045

(52) U.S. Cl. 345/174

(57) ABSTRACT

A capacitive touch panel has a plurality of first transparent electrodes and a plurality of second transparent electrodes on a transparent substrate. At crossing portions between the first and second electrodes, adjacent electrodes of the second electrodes have no interruption, and adjacent electrodes of the first electrodes are interrupted. An interlayer insulating film is disposed as an upper layer on the second electrodes, and a bridge electrode is disposed as an upper layer on the interlayer insulating film to connect interrupted portions of the first electrodes at the crossing portions. The material constituting the bridge electrode contains an element that is more susceptible to oxidation than elements contained in a material constituting the second electrodes. Constant voltage is applied to the first electrodes, and a pulse voltage having a low potential equal to or higher than the potential of the first electrodes is applied to the second electrodes.

### BACKGROUND OF INVENTION

1. Field of Invention

The present invention relates to a touch panel.

2. Discussion of Background

Electronic devices, such as a cellular telephone, a smart phone and a PDA (personal digital assistant), have a limited area for placing an input unit, such as a switch or a digital keypad, since they are required to have a large screen. Further, it is required to realize information input measures wherein a user can input information in an easy-to-understand manner by touching a display image while seeing an image displayed on a display element, such as a liquid crystal display.

Thus, a demand to provide a display with a touch panel has recently increased.

A touch panel is placed on a display element, such as the above-mentioned liquid crystal display, and is a generic term of input units, which detect where a touch is made, when a user touches an operation screen by his or her finger, a pen or the like. The system for detecting where a touch is made is classified into a resistive touch film system, a capacitive touch system and the like.

In such a resistive touch film system, two substrates, each of which has transparent electrodes thereon, are disposed so as to be spaced from each other with the transparent electrodes on both substrates being opposed. The resistive touch film system is configured such that opposed transparent electrodes are brought into contact to cause conduction therebetween when a substrate is pressed by a finger or a pen. Conventional resistive touch film panels are configured such that a substrate is pressed to short-circuit opposed electrodes. For this reason, such conventional resistive touch film panels have a low durability because wear or the like is likely to be caused.

On the other hand, such a capacitive touch system is a system that detects a change in capacitance between a user's fingertip and an electrode in the touch panel in order to detect where a touch is made by the fingertip. This system is said to be appropriate to portable electronic devices. In this system, a projected capacitive touch system has been frequently employed.

In such a projected capacitive touch system, a user's finger serves as ground since the user works as an electrical conductor. In other words, when a finger is brought close to a sensing electrode disposed on a substrate of a touch panel, capacitance is formed between the fingertip and the electrode. The touch panel detects such a change by, e.g. a control circuit. Since a change in capacitance is detected in this system, it is possible to detect the proximity of a fingertip even if a user's fingertip is not brought into direct contact with a sensing electrode.

Such a projected capacitive touch system needs to be subjected to patterning of transparent sensing electrodes for detection. The most frequently used technology is to disposes X-electrodes extending in an X-direction and Y-electrodes extending in a Y-direction in a lattice pattern on one side of a substrate as disclosed in JP-A-60-75927.

FIG. 10 is a schematic plan view explaining the structure of a conventional projected capacitive touch panel.

FIG. 11 is a schematic view explaining the sectional structure of the conventional projected capacitive touch panel.

FIG. 11 is an enlarged view showing the crossing portion between an X-electrode 502 and a Y-electrode 503 in the conventional projected capacitive touch panel 500 shown in FIG. 10.

As shown in FIGS. 10 and 11, the conventional projected capacitive touch panel 500 is configured such that a plurality of X-electrodes 502 and a plurality of Y-electrodes 503 are disposed on a transparent substrate 501, such as a glass substrate. In this configuration, the X-electrodes 502 and the Y-electrodes 503 are disposed, being isolated an insulating film 504 interposed therebetween (not shown in FIG. 10).

Thus, in each of the crossing portions where the X-electrodes 502 and the Y-electrodes 503 overlap with the insulating film 504 being interposed therebetween, capacitance 505 is formed. A change in capacitance, which is caused, e.g. when a user's finger is brought into contact with an electrode, is detected as a change in potential in order to detect where a touch is made.

In such a projected capacitive touch system, it is necessary to dispose one array of electrodes and a different array of electrodes so as to cross each other on a glass substrate forming a touch panel as described above.

With regard to the connection structure between two arrays of electrodes in such a case, e.g. JP-A-2008-310550 discloses a configuration example of a capacitive input unit, which includes a first transparent electrode pattern and a second transparent electrode pattern disposed on one side of a transparent substrate, wherein the second transparent electrode pattern, which is interrupted at crossing portions where both patterns cross each other, is electrically connected by a relay electrode disposed as an upper layer on an interlayer insulating film at each of the crossing portions.

### SUMMARY OF INVENTION

Such a projected capacitive touch panel is classified into two types of self-capacitance type and mutual capacitance type in terms of how to detect a touch by, e.g. a fingertip.

The self-capacitance type detects a change in capacitance in the entire X-electrodes or the entire Y-electrodes. For this reason, if plural positions are touched by e.g. a fingertip or fingertips, it is likely that an error is caused in the detection result of a contacted position.

On the other hand, the mutual capacitance type can detect a change in capacitance in each of the crossing portions between the X-electrodes and the Y-electrodes. For this reason, it is possible to prevent the above-mentioned error from being caused and to carry out accurate position detection even if touching is made at many positions. In other words, it is possible to provide a more sensitive touch panel.

When a mutual capacitance type of projected capacitive touch panel is employed to detect, in the touch panel, a contacted position by, e.g. a fingertip, one of an array of X-electrodes and an array of Y-electrodes is set at a constant voltage to serve as reading wires for detection (hereinbelow, also referred to as sensing lines). The other array is employed as drive wires with a pulse voltage being applied by line-at-a-time-scanning (hereinbelow, also referred to as drive lines). In this case, the presence and absence of contact by, e.g. a fingertip is detected by reading a differential waveform of capacitive coupling formed in each of the crossing portions between the X-electrodes and the Y-electrodes. For this reason, it is necessary to produce a potential difference between the X-electrodes and the Y-electrodes.

The projected capacitive touch panel is required to reduce the resistance of the wires for the purpose of, e.g. increasing detection sensitivity in contact. The touch panel is also required to improve reliability. For these reasons, the X-electrodes and the Y-electrodes are constituted by different materials to meet these requirements in some cases.

Particularly, in the touch panel structure having relay electrodes as disclosed in the above-mentioned JP-A-2008-310550, the relay electrodes can reduce their resistance and increase reliability by being constituted by a different material from the material forming one electrode patterns. This means that the relay electrodes are constituted by a different material from the X-electrodes or the Y-electrodes in the crossing portions between the X-electrodes and the Y-electrodes.

When such a structure is adopted, electrochemical reaction occurs between electrodes overlapping in a crossing portion by a potential difference formed between the X-electrode and the Y-electrode constituted by different materials in some cases.

The reaction occurring in a crossing portion deteriorates an electrode and eventually reduces the reliability of the touch panel. From this point of view, the touch panel needs to reduce electrode deterioration in the crossing portions between the X-electrodes and the Y-electrodes and to be highly reliable.

The present invention is proposed, taking into account the above-mentioned problems in the touch panel.

In other words, it is an object of the present invention to provide a touch panel which controls electrode deterioration and is highly reliable.

Other objects and advantages of the present invention will become apparent from the following detailed description.

According to a first aspect of the present invention, there is provided a capacitive touch panel, which includes:

a transparent substrate;

a plurality of first transparent electrodes extending in a first direction on one side of the substrate; and

a plurality of second transparent electrodes extending in a second direction crossing the first direction on the one side of the substrate with the first electrodes disposed thereon;

wherein at each of crossing portions between the first electrodes and the second electrodes, adjacent electrodes of the second electrodes have no interruption, adjacent electrodes of the first electrodes are interrupted, and the adjacent electrodes of the first electrodes are connected by a bridge electrode;

wherein at each of the crossing portions, an interlayer insulting film is disposed between the bridge electrode and the second electrodes;

wherein the bridge electrode is constituted by a material containing an element, which is more susceptible to oxidation than the elements contained in a material constituting the second electrodes;

wherein a constant voltage is applied to the first electrodes; and

wherein a pulse voltage is applied to the second electrodes, the pulse voltage having a low potential equal to or higher than the potential of the first electrodes.

In the first aspect of the present invention, the bridge electrode is preferably constituted by metal, and the second electrodes is preferably constituted by a material containing at least one substance selected from the group consisting of ITO (Indium Tin Oxide), IZO (Indium Zinc Oxide) and ZnO (Zinc Oxide).

According to a second aspect of the present invention, there is provided a capacitive touch panel, which includes:

a transparent substrate;

a plurality of first transparent electrodes extending in a first direction on one side of the substrate; and

a plurality of second transparent electrodes extending in a second direction crossing the first direction on the one side of the substrate with the first electrodes disposed thereon;

wherein at each of crossing portions between the first electrodes and the second electrodes, adjacent electrodes of the first electrodes have no interruption, adjacent electrodes of the second electrodes are interrupted, and the adjacent electrodes of the second electrodes are connected by a bridge electrode;

wherein at each of the crossing portions, an interlayer insulting film is disposed between the bridge electrode and the first electrodes;

wherein the bridge electrode is constituted by a material containing an element, which are more susceptible to oxidation than the elements contained in a material constituting the first electrodes;

wherein a constant voltage is applied to the first electrodes; and

wherein a pulse voltage is applied to the second electrodes, the pulse voltage having a low potential equal to or lower than the potential of the first electrodes.

In the second aspect of the present invention, the bridge electrode is preferably constituted by metal, and the first electrodes is preferably constituted by a material containing at least one substance selected from the group consisting of ITO (Indium Tin Oxide), IZO (Indium Zinc Oxide) and ZnO (Zinc Oxide).

According to a third aspect of the present invention, there is provided a capacitive touch panel, which includes:

a transparent substrate;

a plurality of first transparent electrodes extending in a first direction on one side of the substrate; and

a plurality of second transparent electrodes extending in a second direction crossing the first direction on the one side of the substrate with the first electrodes disposed thereon;

wherein at each of crossing portions between the first electrodes and the second electrodes, at least an interlayer insulting film is disposed;

wherein adjacent at each of the crossing portions, the electrodes are constituted by the same material;

wherein a constant voltage is applied to the first electrodes; and

wherein a pulse voltage is applied to the second electrodes, the pulse voltage having a low potential equal to the potential of the first electrodes.

In the third aspect of the present invention, it is preferred that at each of the crossing portions, adjacent electrodes of the second electrodes have no interruption, adjacent electrodes of the first electrodes be interrupted, and the adjacent electrodes of the first electrodes be connected by a bridge electrode;

In the third aspect of the present invention, the bridge electrode and the second electrodes are preferably constituted by a material containing at least one substance selected from the group consisting of ITO (Indium Tin Oxide), IZO (Indium Zinc Oxide) and ZnO (Zinc Oxide).

In accordance with the present invention, it is possible to provide a touch panel, which reduces electrode deterioration and is highly reliable.

### BRIEF DESCRIPTION OF DRAWINGS

FIG. 1 is a plan view explaining a schematic structure of the tough panel according to a first embodiment of the present invention;

FIG. 2 is a schematic view explaining the structure of a crossing portion of the touch panel according to the first embodiment;

FIG. 3 is a view showing the structure of the touch panel according to the first embodiment;

FIG. 4 is a schematic cross-sectional view explaining a schematic structure of the touch panel according to the first embodiment;

FIG. 5 is a schematic view showing the relationship between a low potential of drive lines and the potential of sensing lines in the touch panel according to the first embodiment;

FIG. 6 is a view showing the structure of the touch panel according to a second embodiment of the present invention;

FIG. 7 is a schematic cross-sectional view explaining a schematic structure of the touch panel according to the second embodiment;

FIG. 8 is a schematic view showing the relationship between a low potential of drive lines and the potential of sensing lines in the touch panel according to the second embodiment;

FIG. 9 is a schematic view showing the relationship between a low potential of drive lines and the potential of sensing lines in the touch panel according to a third embodiment of the present invention;

FIG. 10 is a schematic plan view explaining the structure of the touch panel of a conventional projected capacitive touch panel; and

FIG. 11 is a schematic view explaining a cross-sectional structure of the conventional projected capacitive touch panel.

### DETAILED DESCRIPTION OF PREFERRED EMBODIMENTS

The touch panel according to embodiments of the present invention is a mutual capacitive type of projected capacitive touch panel. In the touch panel according to the embodiments, transparent electrodes for detecting where a touch is made are formed by patterning. A plurality of first transparent electrodes and a plurality of second transparent electrodes are disposed in a lattice pattern on a single transparent substrate, such as a glass substrate. The first transparent electrodes are disposed so as to extend in a Y-direction, and the second transparent electrodes are disposed so as to extend in an X-direction. One of a couple of adjacent electrodes of the first electrodes and a couple of adjacent electrodes of the second electrodes is interrupted at each of crossing portions where the first electrodes and the second electrodes cross each other, such that the first electrodes and the second electrodes are brought into contact at each of the crossing portions. Adjacent first electrodes or adjacent second electrodes, which are interrupted at each of the crossing portions, are electrically connected by a bridge electrode as a relay electrode. An interlayer insulating film is disposed between the bridge electrode and adjacent first electrodes or adjacent second electrodes, which have no interruption at each of the crossing portions.

In order to increase the conductivity and the reliability of the bridge electrode in this case, the bridge electrode is constituted by a different material from the first electrodes or the second electrodes that are interrupted at each of the crossing portions.

Further, the voltages applied to the respective first and second electrodes are set at the optimum levels in order to detect where a touch is made by, e.g. a fingertip of a user. The optimization is carried out, taking into account the respective materials forming the bridge electrode, the first electrodes and the second electrodes. The optimization is carried out so as to reduce deterioration reaction in the crossing portions.

The electrode deterioration in the crossing portions is caused by constituting the first electrodes and the second electrodes from different conductive materials, thereby to generate a potential difference between the first electrodes and the second electrodes. When the first electrodes, which are constituted so as to contain an element more susceptible to oxidation, are set at a higher potential level than the second electrodes, oxidation-reduction reaction is accelerated. Likewise, when the second electrodes, which are constituted so as to contain elements susceptible to oxidation in comparison those in the first electrodes, are set at a higher potential level than the first electrodes, oxidation-reduction reaction is accelerated.

For example, the bridge electrode may be constituted so as to contain a metal element, which is susceptible to oxidation. Specifically, the bridge electrode may be a metal electrode. Either the first electrodes or the second electrodes, which cross the bride electrode at each of the crossing portions, are constituted by a metal element, which is more difficult to be oxidized than the metal elements employed in the bridge electrode. For example, the first electrodes or the second electrodes, which cross the bride electrode at each of the crossing portions, may be constituted by a transparent conductive material made of a metal oxide, such as ITO. In this case, for example, when the first electrodes or second electrodes that are made of, e.g. ITO are set at a lower potential than the metal bridge electrode, the oxidation-reduction reaction is accelerated, causing metal to elute from the bride electrode and an indium component in ITO to precipitate.

In the touch panel according to the embodiments of the present invention, the respective potential levels of the first electrodes and the second electrodes are optimized so as to reduce electrode deterioration in the crossing portions.

As a result, the touch panel according to the embodiments of the present invention can realize high conductivity and highly reliable performance at the crossing portions and can eventually realize high sensitivity and high reliability.

Now, the touch panel according to the embodiments of the present invention will be described in more detail in reference to the accompanying drawings.

### First Embodiment

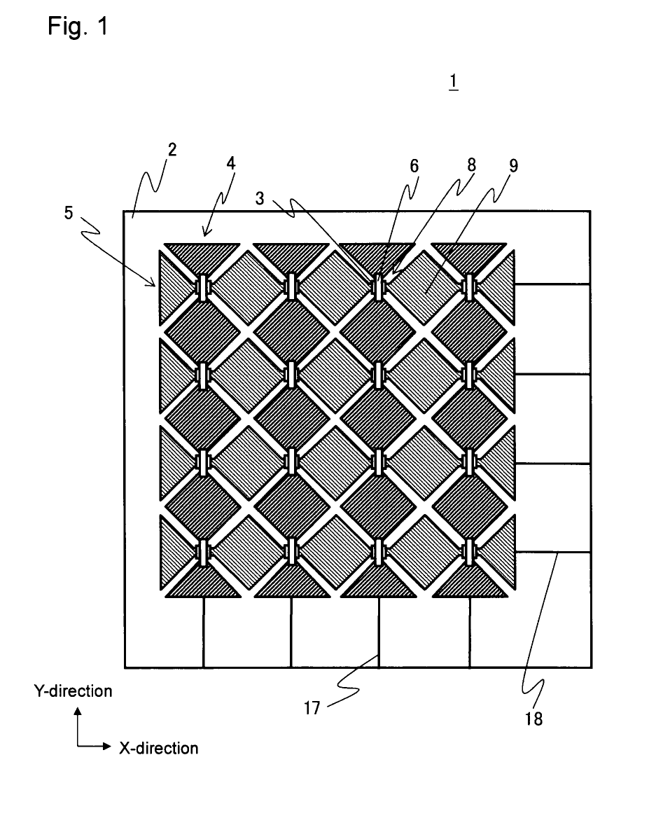

FIG. 1 is a plan view explaining a schematic structure of the tough panel according to a first embodiment of the present invention.

The touch panel 1 shown in FIG. 1 has a plurality of first electrodes 4 and a plurality of second electrodes 5 disposed on one side of a transparent substrate 2 as a light-transmitting substrate.

The transparent substrate 2 is an electrically insulating substrate, which may be, for example, a glass substrate, a PET (polyethylene terephthalate) film or a PC (polycarbonate) film. When the transparent substrate is a glass substrate, the transparent substrate may have a thickness of 0.3 mm to 3.0 mm.

The first electrodes 4 and the second electrodes 5 are all similar light-transmitting electrodes (hereinbelow, also referred to as the transparent electrodes) and are disposed on an area working as the operation screen of the touch panel 1. The first electrodes 4 and the second electrodes 5 are constituted by a transparent material, which has a high transmittance to visible light and a high conductivity. The first electrodes and the second electrodes may be constituted by, e.g. ITO (Indium Tin Oxide), IZO (Indium Zinc Oxide) or ZnO (Zinc Oxide). It is preferred to employ ITO having an excellent conductive performance and an excellent reliability.

As shown in Fig. I, the first electrodes 4 extend in a Y-direction on the transparent substrate 2 while the second electrodes 5 extend in an X-direction orthogonal to the Y-direction on the transparent substrate. The plurality of first electrodes and the plurality of second electrodes are disposed in a lattice pattern on the transparent substrate 2. The plurality of first electrodes 4 divides the operation screen of the touch panel 1 into a plurality of areas to detect a coordinate in the X-direction. The plurality of second electrodes 5 serves to detect a coordinate in the Y-direction in a similar way. On the touch panel I, the plurality of first electrodes 4 and the plurality of second electrodes 5 are electrically independent from each other so as to detect where a touch is made, as describe later.

As shown in Fig. I, the first electrodes 4 and the second electrodes 5 may have such a shape that plural diamond-shaped electrode pads 9 are aligned in the Y-direction and the X-direction.

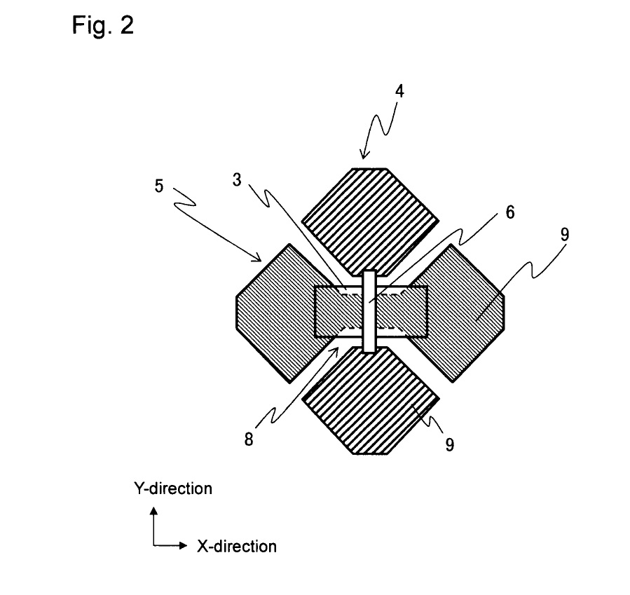

FIG. 2 is a schematic view explaining the structure of a crossing portion of the touch panel according to the first embodiment.

As shown in FIG. 2 in enlargement, the second electrodes 5 are patterned so as to connect between adjacent electrodes at each of crossing portions 8 where the plurality of first electrodes 4 and the plurality of second electrodes 5 cross each other, while the first electrodes 4 are patterned so as to be interrupted between adjacent electrodes. In other words, the second electrodes 5 are electrically connected between adjacent electrodes, while the first electrodes 4 are interrupted between adjacent electrodes. The electrical connection between the interrupted portions of the first electrodes 4 at each of the crossing portions 8 is established by bridge electrodes 6.

The first electrodes 4 and the second electrodes 5 may be constituted by such diamond-shaped electrode pads 9 in order to increase the detection performance of the touch panel. However, the present invention is applicable not only to a case where the electrode pads 9 are formed in a diamond-shape, but also to a case where the electrode pads are formed in any other shape, such as a hexagonal shape or an octagon shape. The number of the first electrodes 4 and the number of the second electrodes 5 are not limited to the shown ones. The shape and the number of the electrodes may be determined, depending on the size of the operation screen and required accuracy of a detected position.

In the touch panel 1 according to the first embodiment shown in Fig. I, the first electrodes 4 and the second electrodes 5 are disposed as the same layer on the same side of the transparent substrate 2 as described above. In other words, there are many crossing portions 8 where the first electrodes 4 and the second electrodes 5 cross each other. As shown in FIG. 2, at each of the crossing portions 8, the second electrodes 5, which are patterned so as to be connected between adjacent electrode pads 9, have an interlayer insulating film 3 disposed as an upper layer thereon. The interrupted portions of the first electrodes 4 are electrically connected by the bridge electrodes 6, which are disposed as an upper layer on the interlayer insulating film 3. In other words, the interlayer insulating film 3 is disposed between a bridge electrode 6 and adjacent electrodes of the second electrodes 5 at each of the crossing portions 8. The interlayer insulating film 3 is disposed only at the crossing portions where the bridge electrodes 6 are disposed.

The interlayer insulating film 3 preferably has a light-transmissive property by being constituted by a light transmissive and insulating material. The interlayer insulating film may be constituted by, e.g. an inorganic material, such as SiO₂, or an organic material, such as a photosensitive acrylic resin. When SiO₂ is employed, it is possible to readily obtain the insulating film by patterning by use of a mask in a sputtering method. When such a photosensitive acrylic resin or the like is employed to dispose the interlayer insulating film, it is possible to obtain the interlayer insulating film 3 by patterning the resin by use of a photolithographic technique.

In particular, when the transparent substrate 2 is a glass substrate, it is preferred to employ a photosensitive resin, which has a group reactive with a silanol group generated on the glass substrate. By employing such a photosensitive resin, it is possible to provide the insulating layer with a high adhesion property due to chemical bond between the glass substrate and the photosensitive resin. Preferred examples of the photosensitive resin include a photosensitive methacrylic resin, a photosensitive polyimide resin, a photosensitive polysiloxane resin, a photosensitive polyvinyl alcohol resin and an acrylic-urethane-based photosensitive resin in addition to the above-mentioned photosensitive acrylate resin. The interlayer insulating film may be constituted by a light blocking insulating material. When such a light blocking insulating material is employed, it is preferred that the area where the interlayer insulating film 3 is disposed be minimized from the viewpoint of visibility.

The bridge electrodes 6 according to the first embodiment are preferably constituted by a metal material. The metal material is an appropriate material because of having a high adhesion property to the transparent substrate 2. When the transparent substrate 2 is a glass substrate, it is preferred to employ a material, which has a high adhesion property to the glass substrate, has a high conductivity and is excellent in durability and wear resistance. It is possible to make the touch panel highly sensitive and highly reliable by employing such a metal material to form the bridge electrodes 6.

The metal material forming the bridge electrodes 6 may be, for example, Mo, a Mo alloy, Al, an Al alloy, Au and an Au alloy. Preferred examples of an alloy having an improved corrosion resistance include a Mo—Nb-based alloy and an Al—Nd-based alloy. The above-mentioned bridge electrodes 6 may have a multi-layer structure, such as a two-layer structure or a three-layer structure. An example of the multi-layer structure is a three-layer structure of Mo-layer/Al-layer/Mo-layer.

When the bridge electrodes 6 are constituted by such a metal material, it is possible to make the electrode width narrower and make the electrode length longer in comparison with a case where the bridge electrodes 6 are constituted by, e.g. an ITO material as a transparent material. It is also possible to reduce the electrode film thickness. Such bridge electrodes 6 can increase the degree of freedom in designing of the electrode structure and have a better appearance.

In the step where a metal film is patterned to dispose the above-mentioned bridge electrodes 6, the metal film may be simultaneously patterned so as to dispose lead-out wires 17 for connection with the first electrodes 4 and lead-out wires 18 for connection with the second electrodes 5. Thus, it is possible to reduce the resistance of the lead-out wires 17 and 18.

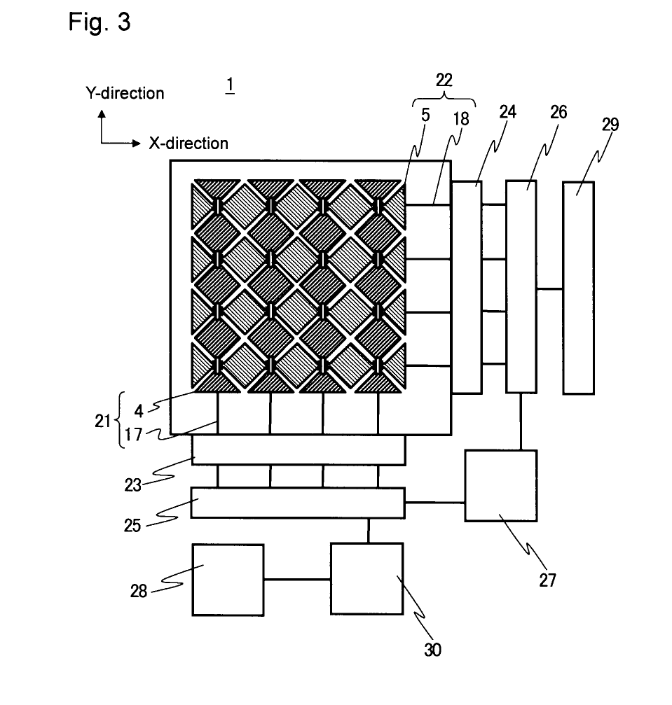

FIG. 3 is a view showing the structure of the touch panel according to the first embodiment.

In the touch panel 1 according to the first embodiment, the first electrodes 4 and the lead-out wires 17 form sensing lines 21. On the other hand, the second electrodes 5 and the lead-out wires 18 form drive lines 22.

The drive lines 22 are connected to a drive voltage output circuit 24 for outputting a pulse voltage as a drive voltage. The drive voltage output circuit 24 is connected to a selection circuit 26, and the selection circuit 26 is connected to a drive voltage generation circuit 29. The voltage applied to the drive lines 22 is generated by the drive voltage generation circuit 29. Under the control of the selection circuit 26, the drive voltage output circuit 24 applies a pulse voltage to a selected drive line 22 among the plural drive lines 22. For example, the pulse voltage may be applied by line-at-a-time-scanning.

The sensing lines 21 are connected to a sensing voltage output circuit 23 for outputting a constant voltage, and the sensing voltage output circuit 23 is connected to a selection circuit 25. Under the control of the selection circuit 25, the sensing voltage output circuit 23 applies a constant voltage to a selected sensing line 21 among the plural sensing lines 21. For example, the constant voltage may be applied to the sensing lines 21 by line-at-a-time-scanning.

The timing of the voltage applications to the drives lines 22 and the sensing lines 21 is selected under the control of a timing controller 27. In other words, the synchronization of the voltage application timing that is required between the sensing lines 21 and the drive lines 22 is realized by the timing controller 27.

With regard to the sensing lines 21, the selection circuit 25 is connected to an operational circuit 28 through an A/D converter 30. The operation circuit 28 reads a differential waveform of capacitive coupling formed at a crossing portion between a drive line 22 and a sensing line 21 by touch of, e.g. a fingertip. Thus, it is detected whether a touch has been made by, e.g. a fingertip, and which position is touched on the operation screen of the touch panel 1.

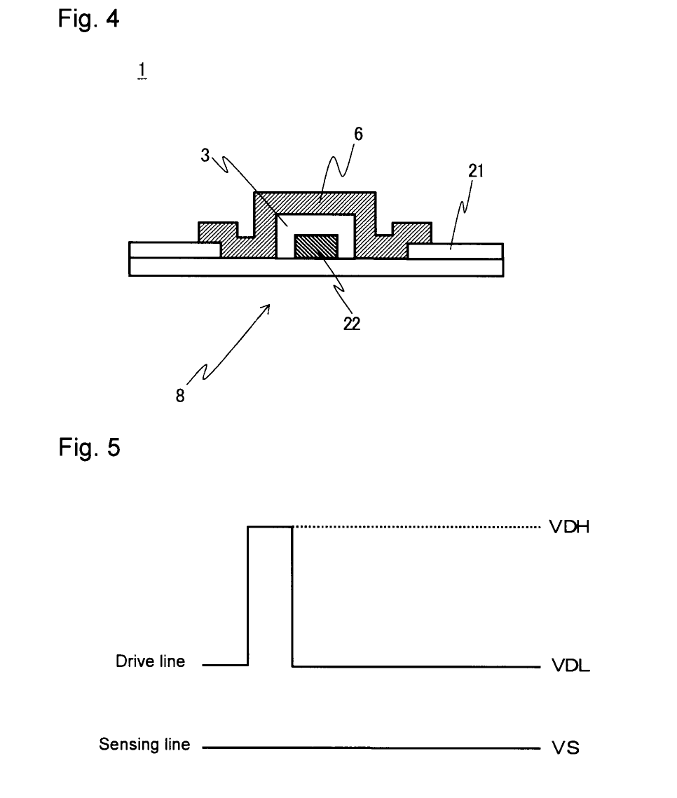

FIG. 4 is a schematic cross-sectional view explaining a schematic structure of the touch panel according to the first embodiment.

As shown in FIG. 4, in the touch panel 1 according to the first embodiment, the transparent substrate 2 has the plurality of first transparent electrodes 4 and the plurality of second transparent electrodes 5 disposed in a lattice pattern on the one side thereof. The first electrodes 4 form the sensing lines 21 while the second electrodes 5 form the drive lines 22. The sensing lines 21 are configured so as to be interrupted at the crossing portions 8 such that the sensing lines are not brought into contact with the drive lines at the crossing portions 8 where the sensing lines and the drive lines cross each other. The interrupted portions of the sensing lines 21 are electrically connected by the bridge electrodes, which are disposed as an upper layer on the interlayer insulating film 3. In this embodiment, the bridge electrodes 6, which connect the interrupted portions of the sensing lines 21, are made of metal.

In this embodiment, the pulse voltage is applied to the drive lines 22 by the drive voltage output circuit 24. The pulse voltage has a low potential (hereinbelow, also referred to as VDL) and a high potential (hereinbelow, also referred to as VDH) set at respective desired level. On the other hand, the constant voltage (hereinbelow, also referred to as VS) is applied to the sensing lines 21 by the sensing voltage output circuit 23. What is applied to the drive lines 22 is the pulse voltage. This means that the potential of the drive lines 22 is at such a low potential (VDL) level for most of the period of time where the touch panel is driven. When the oxidation-reduction reaction of the electrodes, such as electrical corrosion, should be taken into account, the level of this VDL becomes problematic.

For example, when the VDL of the drive lines 22 is higher than the VS of the sensing lines 21, a low-resistance portion close to each of the crossing portions 8, such as an inner portion of the interlayer insulating film 3, forms a leak path. In some cases, oxidation-reduction reaction occurs in an electrode at such a crossing portion 8. Specifically, when the bridge electrodes forming the sensing lines 21 are made of aluminum, the employed aluminum is oxidized to be subjected to electrical corrosion. On the other hand, for example, when the drive lines 22 are made of ITO, the indium component in ITO precipitates as metal. Thus, the electrodes at the crossing portions 8 are deteriorated.

The reason why the electrodes at the crossing portions 8 deteriorate is that the sensing lines 21 and the drive lines 22 are formed by materials having different conductivities and that a potential difference is set between the sensing lines and the drive lines. When the sensing lines 21 contain an element, which is more susceptible to oxidation than the elements contained in the material forming the drive lines 22, and when the sensing lines 21 is set at a higher potential level than the drive lines 22, oxidation-reduction reaction is accelerated. Likewise, when the drive lines 22 contain an element, which is more susceptible to oxidation than the elements contained in the material forming the sensing lines 21, and when the drive lines are set at a higher potential level than the sensing lines 21, oxidation-reduction reaction is accelerated.

From this point of view, in the touch panel 1 according to the first embodiment, what materials should be employed to form the sensing lines 21 and the drive lines 22 should be taken into account. Further, the respective set potentials at the time of driving the touch panel 1 are determined so as to have the optimum relation. Thus, the advance of the oxidation-reduction action of the electrodes at the crossing portions 8 is controlled.

FIG. 5 is a schematic view showing the relationship between a low potential of the drive line and a potential of the sensing line in the touch panel according to the first embodiment.

In the touch panel 1 according to the first embodiment, the relationship between the VDL of the pulse voltage applied to the drive lines 22, and the VS applied to the sensing lines 21 and the bridge electrodes 6 forming the sensing lines 21 is optimized. Specifically, the relationship is set so as to satisfy the formula of VS≦VDL as shown in FIG. 5

By setting the relationship as described above, it is possible to control the oxidation-reduction reaction in the metal bridge electrodes 6 forming the sensing lines 21 and to prevent the electrodes from being electrically corroded at the crossing portions 8.

Accordingly, it is possible to employ a metal material having a high conductivity to form the bridge electrodes 6, to control the deterioration reaction of the electrodes at the crossing portions 8 and to have a high sensitivity and a high reliability in the touch panel 1 according to the first embodiment.

In the touch panel according to this embodiment, the drive lines may be constituted by metal bridge electrodes.

### Second Embodiment

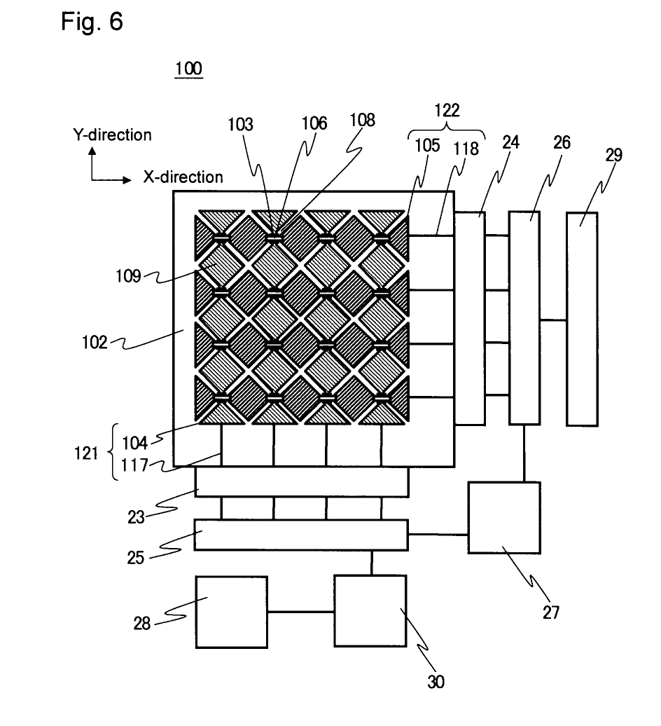

FIG. 6 is a view showing the structure of the touch panel according to a second embodiment of the present invention.

In the touch panel 100 as another example shown in FIG. 6, first electrodes 104, lead-out wires 117, which extend in the Y-direction, form sensing lines 121. Second electrodes 105 and lead-out wires 118, which extend in the X-direction, form drive lines 122.

As shown in FIG. 6, the first electrodes 104 are patterned so as to connect between adjacent electrodes at each of crossing portions 108 where the first electrodes 104 and the second electrodes 105 cross each other. On the other hand, the second electrodes 105 are patterned so as to be interrupted between adjacent electrodes at each of the crossing portions 108. In other words, the first electrodes 104 are electrically connected between adjacent electrodes, while the second electrodes 105 are interrupted between adjacent electrodes. The electrical connection between the interrupted portions of the second electrodes 105 at the crossing portions 108 is established by bridge electrodes 106.

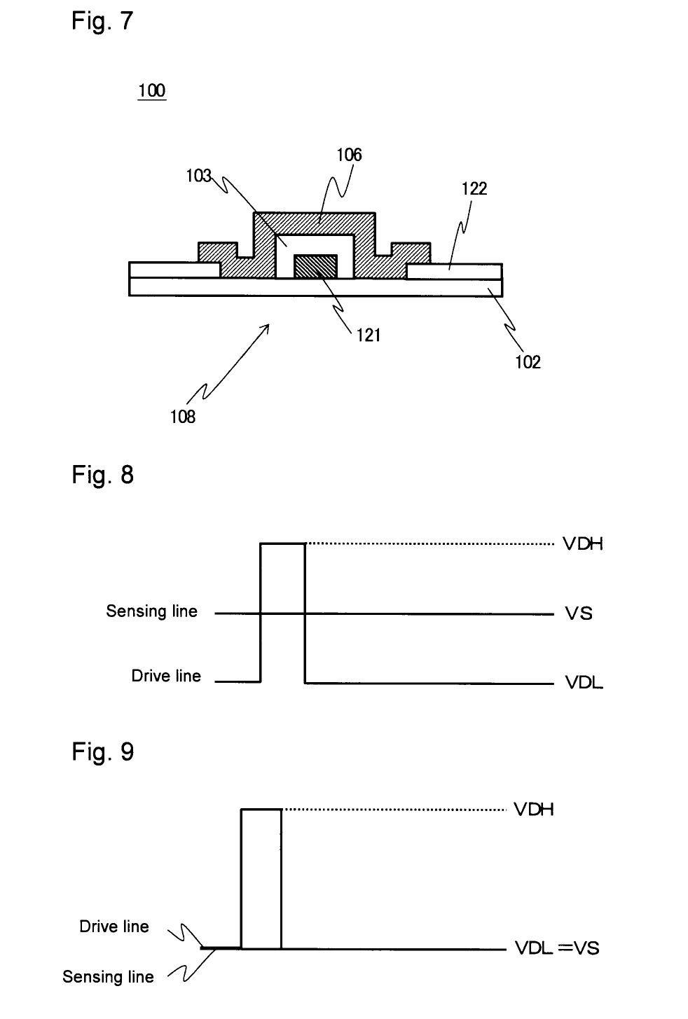

The structures and the functions of the other constituent elements are the same as those of the above-mentioned touch panel 1 according to the first embodiment. For this reason, the essential portions will be mainly described, and the common constituent elements will be described, being indicated by the same reference numerals. This is also applicable to FIG. 7 described later.

In the touch panel 100 according to the second embodiment shown in FIG. 6, the first electrodes 104 and the second electrodes 105 are disposed as the same layer on the same side of the transparent substrate 102 as described above. In other words, there are many crossing portions 108 where the first electrodes 104 and the second electrodes 105 cross each other. At each of the crossing portions 108, the first electrodes 104, which are patterned so as to be connected between adjacent electrode pads 109, have an interlayer insulating film 103 disposed as an upper layer thereon. The interrupted portions of the second electrodes 105 are electrically connected by the bridge electrodes 106, which are disposed as an upper layer on the interlayer insulating film 103. In other words, the interlayer insulating film 103 is disposed between a bridge electrode 106 and adjacent electrodes of the first electrodes 104 at each of the crossing portions 108. The interlayer insulating film 103 may be disposed only at the crossing portions where the bridge electrodes 106 are disposed.

The drive lines 122 are connected to the drive voltage output circuit 24 for outputting a pulse voltage as a drive voltage. The drive voltage output circuit 24 is connected to the selection circuit 26, and the selection circuit 26 is connected to the drive voltage generation circuit 29. The voltage applied to the drive lines 22 is generated by the drive voltage generation circuit 29. Under the control of the selection circuit 26, the drive voltage output circuit 24 applies a pulse voltage to a selected drive line 122 among the plural drive lines 122. For example, the pulse voltage may be applied by line-at-a-time-scanning.

The sensing lines 121 are connected to the sensing voltage output circuit 23 for outputting a constant voltage, and the sensing voltage output circuit 23 is connected to the selection circuit 25. Under the control of the selection circuit 25, the sensing voltage output circuit 23 applies a constant voltage to a selected sensing line 121 among the plural sensing lines 121. For example, the constant voltage may be applied to the sensing lines 121 by line-at-a-time-scanning.

The timing of the voltage applications to the driving lines 122 and the sensing lines 121 is selected under the control of the timing controller 27. In other words, the synchronization of the voltage application timing that is required between the sensing lines 121 and the drive lines 122 is realized by the timing controller 27.

With respect to the sensing line 121, the selection circuit 25 is connected to the operation circuit 28 through the A/D converter 30. The operation circuit 28 reads a differential waveform of capacitive coupling formed at the crossing portion between a drive line 122 and a sensing line 121 by touch of, e.g. a fingertip. Thus, it is detected whether a touch has been made by, e.g. a fingertip and which position is touched on the operation screen of the touch panel 100.

FIG. 7 is a schematic cross-sectional view explaining a schematic structure of the touch panel according to the second embodiment.

As shown in FIG. 7, in the touch panel 100 according to the second embodiment, the transparent substrate 102 has the plurality of first transparent electrodes and the plurality of second transparent electrodes disposed in a lattice pattern on one side thereof. The first electrodes form the sensing lines 121 while the second electrodes form the drive lines 122. The drive lines 122 are interrupted at the crossing portions 108 such that the drive lines are not brought into contact with the sensing lines 121 at the crossing portions 108 where the drive lines and the sensing lines cross each other. The interrupted portions of the drive lines 122, which are interrupted at the crossing portions 108, are electrically connected by the bridge electrodes 106 disposed as the upper layer on the interlayer insulating film 103. The bridge electrodes 106, which connect the interrupted portions of the drive lines 122, are made of metal as in the above-mentioned touch panel 101.

In this embodiment, the pulse voltage is applied to the drive lines 122 by the drive voltage output circuit 24. The pulse voltage is set such that the VDL and the VDH have respective desired levels. A low potential (VS) is applied to the sensing lines 121 by the sensing voltage output circuit 23. What is applied to the drive lines 122 is the pulse voltage. This means that the drive lines 122 is placed at the level of the VDL for most of the period of time where the touch panel 100 is driven. When the oxidation-reduction reaction of the electrodes, such as electrical corrosion, should be taken into account, the level of the VDL become problematic.

For example, when the VDL of the drive lines 122 is higher than the VS of the sensing lines 121, a low-resistance portion close to each crossing portion 108, such as an inner portion of the interlayer insulating film 103, forms a leak path. In some cases, oxidation-reduction reaction occurs in an electrode at such a crossing portion 108. Specifically, when the bridge electrodes 106 forming the drive lines 122 are made of aluminum, aluminum is oxidized to be subjected to electrical corrosion. On the other hand, for example, when the sensing lines 121 are made of ITO, the indium component in ITO precipitates as metal. Thus, the electrodes at the crossing portions 108 are deteriorated.

From this point of view, in the touch panel 100 according to the second embodiment, what materials should be employed to form the sensing lines 121 and the drive lines 122 should be taken into account. Further, the respective set potentials for the sensing lines 121 and the drive lines 122 at the time of driving the touch panel are determined so as to have the optimum relationship. Thus, the advance of the oxidation-reduction reaction at the crossing portions 108 is controlled.

FIG. 8 is a schematic view showing the relationship between a low potential of the drive lines and the potential of the sensing lines in the touch panel according to the second embodiment.

In the touch panel 100 according to the second embodiment, the relationship between the VDL of the pulse voltage applied to the drive lines 122 and the bridge electrodes 106, and the VS applied to the sensing lines 121 is optimized. Specifically, the relationship is determined so as to satisfy the formula of VS≧VDL as shown in FIG. 8.

By this setting, the oxidation-reduction reaction of the metal bridge electrodes 106 forming the drive lines 122 is controlled, whereby the electrodes are prevented from being electrically corroded at the crossing portions 108.

Thus, it is possible to employ a metal material having a high conductivity to form the bridge electrodes 106, to control the deterioration reaction of the electrodes at the crossing portions 108 and to realize a high sensitive and a high reliability in the touch panel 100 according to the second embodiment.

### Third Embodiment

In the touch panel according to the present invention, it becomes possible to constitute the sensing lines and the drive lines by the same material by optimizing the relationship between the VDL of the pulse voltage applied to the drive lines and the VS applied to the sensing lines. It is possible to provide the touch panel according to a third embodiment, which includes the sensing lines and the drive lines constituted by the same material and has the similar structure as the above-mentioned embodiments in terms of the other structure.

FIG. 9 is a schematic view showing the relationship between a low potential of the drive lines and the potential of the sensing lines in the touch panel according to the third embodiment.

Specifically, in the above-mentioned touch panel according to the third embodiment, the bridge electrodes may be constituted by a transparent conductive material selected from ITO, IZO and ZnO. The sensing lines and the drive lines, which cross each other at the crossing portions, are also constituted by the same transparent conductive materials.

In this case, the relationship between the VDL and the VS is determined so as to satisfy the formula of VDL=VS. For example, when the bridge electrodes are made of ITO, it is possible to control the reduction reaction of ITO at the crossing portions between the sensing lines and the drive lines and to control the precipitation of an indium component by setting such a relationship.

Accordingly, it is possible to control the reduction and the precipitation of a metal component of the material forming the electrodes by configuring the touch panel so as to satisfy the formula of VDL=VS. Thus, it is possible to control the electrode deterioration at the crossing portions.

In the touch panel according to this embodiment, it is possible to employ a metal material to form the bridge electrodes and employ the same metal material to form the first electrodes and the second electrodes, which overlap at the crossing portions. By adopting such a structure and setting the relationship between the VDL and the VS to satisfy the formula of VDL=VS, it is possible to control the electrical corrosion of the electrodes at the crossing portions.

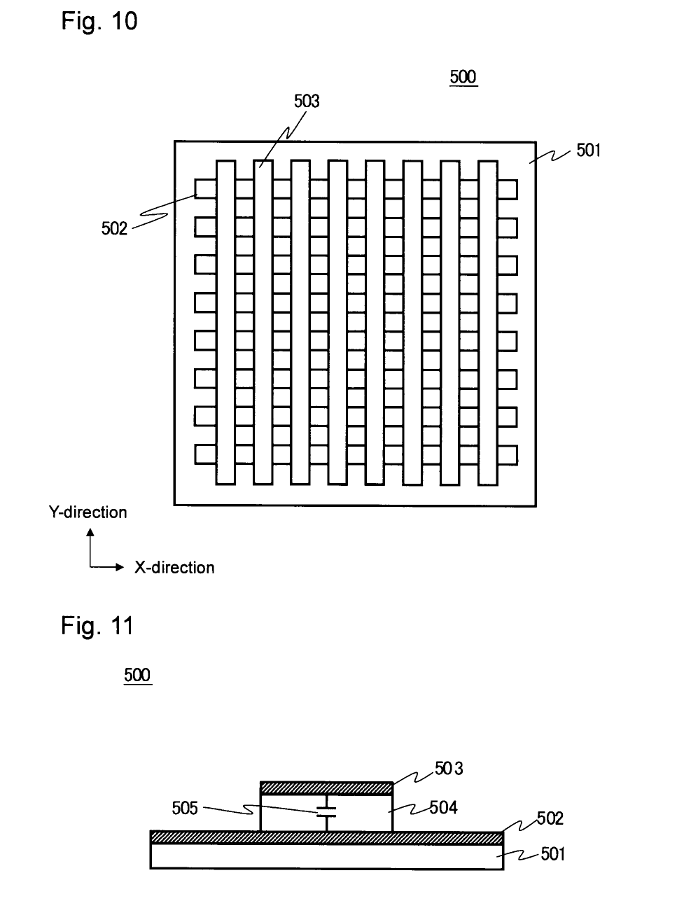

It should be noted that the present invention is not limited to the above-mentioned embodiments, and that various modifications may be made within a range not to depart from the concept of the present invention. For example, although explanation of the third embodiment has been made about a case where the electrodes at the crossing portions are constituted by the bridge electrodes and the second electrodes, the electrodes at the crossing portions may be formed in an electrode shape shown in FIG. 10 without employing the bridge electrodes. The interlayer insulating film may be entirely disposed on the one side of the substrate, being not limited to the crossing portions, so as to entirely cover one array of electrodes, and the other array of electrodes, which cross the one array of electrodes, may be disposed on the interlayer insulating film disposed on the entire side.

The entire disclosure of Japanese Patent Application No. 2010-278643 filed on Dec. 14, 2010 including specification, claims, drawings and summary is incorporated herein by reference in its entirety.

What is claimed is:

1. A capacitive touch panel comprising:
a transparent substrate;
a plurality of first transparent electrodes extending in a first direction on one side of the substrate; and
a plurality of second transparent electrodes extending in a second direction crossing the first direction on the one side of the substrate with the first electrodes disposed thereon;
wherein at each of crossing portions between the first electrodes and the second electrodes, adjacent electrodes of the second electrodes have no interruption, adjacent electrodes of the first electrodes are interrupted, and the adjacent electrodes of the first electrodes are connected by a bridge electrode;
wherein at each of the crossing portions, an interlayer insulting film is disposed between the bridge electrode and the second electrodes;
wherein the bridge electrode is constituted by a material containing an element, which is more susceptible to oxidation than the elements contained in a material constituting the second electrodes;
wherein a constant voltage is applied to the first electrodes; and
wherein a pulse voltage is applied to the second electrodes, the pulse voltage having a low potential equal to or higher than the potential of the first electrodes.

2. The touch panel according to claim 1, wherein the bridge electrode is constituted by metal, and the second electrodes is constituted by a material containing at least one substance selected from the group consisting of ITO (Indium Tin Oxide), IZO (Indium Zinc Oxide) and ZnO (Zinc Oxide).

3. A capacitive touch panel comprising:
a transparent substrate;
a plurality of first transparent electrodes extending in a first direction on one side of the substrate; and
a plurality of second transparent electrodes extending in a second direction crossing the first direction on the one side of the substrate with the first electrodes disposed thereon;
wherein at each of crossing portions between the first electrodes and the second electrodes, adjacent electrodes of the first electrodes have no interruption, adjacent electrodes of the second electrodes are interrupted, and the adjacent electrodes of the second electrodes are connected by a bridge electrode;
wherein at each of the crossing portions, an interlayer insulting film is disposed between the bridge electrode and the first electrodes;
wherein the bridge electrode is constituted by a material containing an element, which is more susceptible to oxidation than the elements contained in a material constituting the first electrodes;
wherein a constant voltage is applied to the first electrodes; and
wherein a pulse voltage is applied to the second electrodes, the pulse voltage having a low potential equal to or lower than the potential of the first electrodes.

4. The touch panel according to claim 3, wherein the bridge electrode is constituted by metal, and the first electrodes is constituted by a material containing at least one substance selected from the group consisting of ITO (Indium Tin Oxide), IZO (Indium Zinc Oxide) and ZnO (Zinc Oxide).

5. A capacitive touch panel comprising:
a transparent substrate;
a plurality of first transparent electrodes extending in a first direction on one side of the substrate; and
a plurality of second transparent electrodes extending in a second direction crossing the first direction on the one side of the substrate with the first electrodes disposed thereon;
wherein at each of crossing portions between the first electrodes and the second electrodes, at least an interlayer insulting film is disposed;
wherein adjacent at each of the crossing portions, the electrodes are constituted by the same material;
wherein a constant voltage is applied to the first electrodes; and
wherein a pulse voltage is applied to the second electrodes, the pulse voltage having a low potential equal to the potential of the first electrodes.

6. The touch panel according to claim 5, wherein at each of the crossing portions, adjacent electrodes of the second electrodes have no interruption, adjacent electrodes of the first electrodes are interrupted, and the adjacent electrodes of the first electrodes are connected by a bridge electrode.

7. The touch panel according to claim 6, wherein the bridge electrode and the second electrodes are constituted by a material containing at least one substance selected from the group consisting of ITO (Indium Tin Oxide), IZO (Indium Zinc Oxide) and ZnO (Zinc Oxide).
